(19) United States
(12) Patent Application Publication
(10) Pub. No.: US 2012/0182388 A1
(43) Pub. Date: Jul. 19, 2012

(54) APPARATUS AND METHOD FOR PROCESSING DEPTH IMAGE

(75) Inventors: Il Soon LIM, Hongseong-gun (KR); Jae Joon LEE, Seoul (KR)

(73) Assignee: SAMSUNG ELECTRONICS CO., LTD., Suwon-si (KR)

(21) Appl. No.: 13/352,935

(22) Filed: Jan. 18, 2012

Related U.S. Application Data
(60) Provisional application No. 61/434,567, filed on Jan. 20, 2011.

(30) Foreign Application Priority Data
Jan. 18, 2011 (KR) 10-2011-0005038
May 3, 2011 (KR) 10-2011-0041902

(51) Int. Cl. H04N 13/00; H04N 7/32; G06K 9/00

(52) U.S. Cl. 348/43; 382/154; 375/240.03; 348/E13.002; 375/E07.027; 375/E07.125; 375/E07.194

(57) ABSTRACT

An apparatus and method for processing a depth image are provided. A compressed depth image may be divided into a plurality of regions, and may be processed, and thus it is possible to improve a quality of the compressed depth image, and to increase a compression rate.

### CROSS-REFERENCE TO RELATED APPLICATIONS

This application claims the benefit of U.S. Provisional Application No. 61/434,567, filed on Jan. 20, 2011, in the United States Patent and Trademark Office, Korean Patent Application No. 10-2011-0005038, filed on Jan. 18, 2011, in the Korean Intellectual Property Office, and Korean Patent Application No. 10-2011-0041902, filed on May 3, 2011, in the Korean Intellectual Property Office the disclosure of which is incorporated herein by reference.

### BACKGROUND

1. Field

Example embodiments of the following description relate to an apparatus and method for processing a depth image, and more particularly, to an apparatus and method that may process a depth image of a stereoscopic image.

2. Description of the Related Art

A stereoscopic image compression system is used to compress a color image and a depth image, namely, a depth map. A color image may be efficiently compressed using a scheme such as an H.264/Advanced Video Coding (AVC) scheme, an H.264/Multiview Video Coding (MVC) scheme, a High Efficiency Video Coding (HEVC) scheme, and the like. However, since a depth image is completely different in characteristic from a color image, researches need to be conducted on information regarding a scheme of efficiently compressing a depth image. In other words, the depth image refers to data representing a spatial distance between an object and a viewer using a gray level, and has a characteristic that most of smooth regions and a few discontinuous outlines are used to form the depth image. Accordingly, new compression information on the depth image is being required.

In a conventional scheme, to improve degradation in image quality of a depth image due to compression, a Low Pass Filter (LPF) is applied to the depth image as a pre-processing operation, the depth image where the LPF is applied is input to a compression system, and the input depth image is compressed. The conventional scheme advantageously improves a compression rate of the depth image by entirely blurring the depth image. However, since discontinuous outlines having a great influence on the image quality are also blurred by the conventional scheme, the image quality is reduced.

### SUMMARY

The foregoing and/or other aspects are achieved by providing an apparatus for processing a depth image, the apparatus including a region division unit to divide a compressed depth image into a plurality of regions, to compute a flatness for each of the plurality of regions, and to classify the plurality of regions into a plurality of classes based on the flatness, a filter parameter value determination unit to determine a filter parameter value corresponding to each of the plurality of classes, and an image filtering unit to perform an image filtering for each of the plurality of classes based on the filter parameter value.

The foregoing and/or other aspects are also achieved by providing a method for processing a depth image, the method including dividing a compressed depth image into a plurality of regions, computing a flatness for each of the plurality of regions, classifying the plurality of regions into a plurality of classes based on the flatness, determining a filter parameter value corresponding to a restoration filter, for each of the plurality of classes, and performing an image filtering for each of the plurality of classes, based on the filter parameter value.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a block diagram of a configuration of a depth image processing apparatus according to example embodiments;

FIG. 2 illustrates a diagram of a depth image divided by a block-based division scheme according to example embodiments;

FIG. 3 illustrates a diagram of a depth image divided by a quad tree-based division scheme according to example embodiments;

FIG. 4 illustrates a diagram of a bypass area according to example embodiments;

FIGS. 5 and 6 illustrate diagrams of subsample regions according to example embodiments;

FIG. 7 illustrates a diagram of a video data encoder including a depth image processing apparatus in an in-loop position according to example embodiments;

FIG. 8 illustrates a diagram of a video data decoder including a depth image processing apparatus in an in-loop position according to example embodiments;

FIG. 9 illustrates a diagram of a video data encoder including a depth image processing apparatus in a position of a post filter according to example embodiments;

FIG. 10 illustrates a diagram of a video data decoder including a depth image processing apparatus in a position of a post filter according to example embodiments;

FIG. 11 illustrates a diagram of a video data encoder including a depth image processing apparatus in a position of an adaptive interpolation filter according to example embodiments;

FIG. 12 illustrates a diagram of a video data decoder including a depth image processing apparatus in a position of an adaptive interpolation filter according to example embodiments; and

FIG. 13 illustrates a flowchart of a depth image processing method according to example embodiments.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

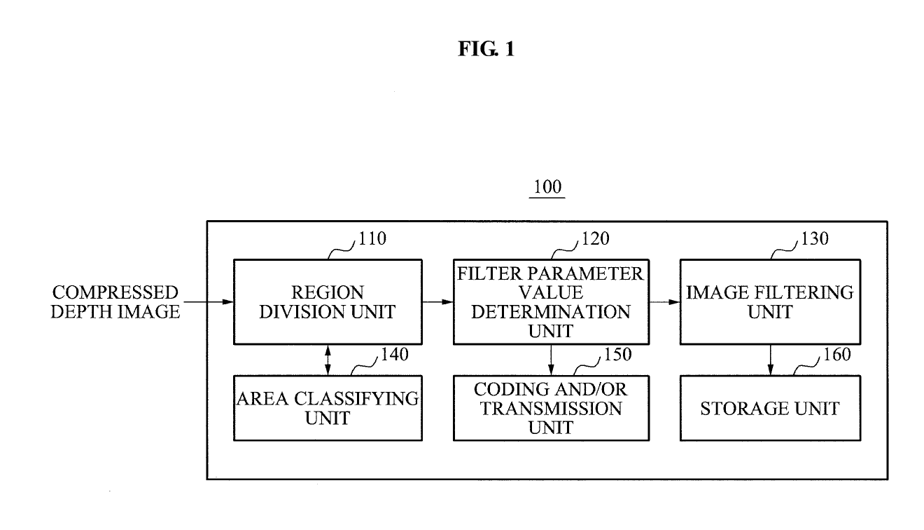

FIG. 1 illustrates a block diagram of a configuration of a depth image processing apparatus 100 according to example embodiments.

Referring to FIG. 1, the depth image processing apparatus 100 may include a region division unit 110, a filter parameter value determination unit 120, and an image filtering unit 130.

The region division unit 110 may divide a compressed depth image into a plurality of regions.

Specifically, the region division unit 110 may divide the compressed depth image into the plurality of regions, based on one of a block-based division scheme and a quad tree-based division scheme. It is also understood that the region division unit 110 may divide the compressed depth image into the plurality of regions based on one of an object-based division scheme.

Additionally, the region division unit 110 may compute a flatness for each of the plurality of regions.

According to an aspect, the flatness may be a difference between a maximum pixel value and a minimum pixel value in each of the plurality of regions.

For example, when a compressed depth image is divided into ‘4×4’ regions, namely, 16 regions, the region division unit 110 may compute a flatness for each of the 16 regions. In this example, the region division unit 110 may extract a maximum pixel value and a minimum pixel value from a plurality of pixels included in a first region among the 16 regions, may compute a difference between the extracted maximum pixel value and the extracted minimum pixel value, and may compute a flatness of the first region. Similarly, the region division unit 110 may repeatedly perform a flatness computation operation for each of the other 15 regions, to compute a flatness for each of the other 15 regions.

According to another aspect, the flatness may be a variance of a pixel value in each of the plurality of regions.

According to another aspect, the flatness may be a spatial activity of a pixel in each of the plurality of regions. The spatial activity may represent a gradient of a pixel.

The region division unit 110 may classify the plurality of regions into a plurality of classes, based on the computed flatness.

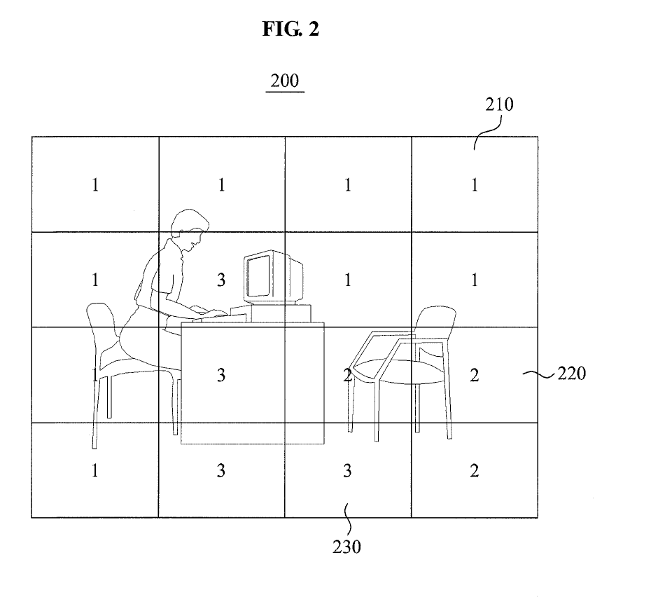

FIG. 2 illustrates a diagram of a depth image divided by a block-based division scheme according to example embodiments.

Referring to FIG. 2, a region division unit of a depth image processing apparatus according to example embodiments may divide a depth image 200 into a plurality of blocks, namely a plurality of regions. Here, a single block may correspond to a single region classified as a class.

Depending on example embodiments, a number of blocks may be optionally set. For example, the region division unit may divide the depth image 200 into ‘4×4’ blocks, ‘8×8’ blocks, ‘16×16’ blocks, and the like.

The region division unit may compute a flatness for each of the plurality of blocks, namely the regions, and may classify the plurality of blocks, namely the regions, based on classes. For example, the region division unit may classify blocks 210, 220, and 230 as classes 1, 2, and 3, respectively.

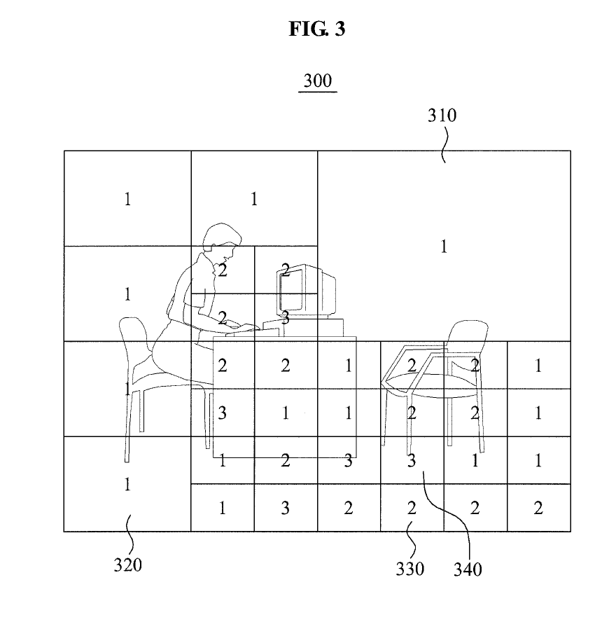

FIG. 3 illustrates a diagram of a depth image divided by a quad tree-based division scheme according to example embodiments.

Referring to FIG. 3, a region division unit of a depth image processing apparatus according to example embodiments may divide a depth image 300 into four regions, and may compute a flatness for each of the four regions. Here, when a flatness of a region among the four regions corresponds to a class 1, the region may be classified as the class 1, and may not be divided anymore. For example, when a flatness of a region 310 has a value of “0” to “20,” the region division unit may classify the region 310 as the class 1, and may not divide the region 310 anymore.

Additionally, when a flatness of another region among the four regions does not correspond to the class 1, the region division unit may again divide the other region into four subregions. The region division unit may again compute a flatness for each of the four subregions. When a flatness of a subregion among the four subregions corresponds to the class 1, the subregion may be classified as the class 1, and may not be divided anymore. For example, when a flatness of a region 320 has a value of “0” to “20,” the region division unit may classify the region 320 as the class 1, and may not divide the region 320 anymore.

In other words, when a depth image is divided by the quadtree-based division scheme, the region division unit may not divide a region having a flatness corresponding to the class 1 anymore, and may repeatedly perform subdivision on regions having flatnesses corresponding to classes other than the class 1.

The region division unit may set limits to a number of subdivisions. When the same number of subdivisions as the limits are performed, but when a flatness of a subregion does not correspond to the class 1, the region division unit may stop the subdivisions. For example, when the limits to the number of subdivisions is set to “3,” and when a flatness of a region 330, and a flatness of a region 340 respectively correspond to a class 2 and a class 3, the region division unit may stop the subdivisions.

Referring back to FIG. 1, the depth image processing apparatus 100 may further include an area classifying unit 140.

The area classifying unit 140 may classify the compressed depth image into a bypass area and a restoration area, based on compression information regarding the compressed depth image.

The compression information may include at least one of a scheme used to compress the depth image, motion information, an intra prediction mode, and a direction of a residue.

Here, the region division unit 140 may divide, into a plurality of regions, a portion of the compressed depth image that is classified as a restoration area. In other words, the region division unit may divide, into a plurality of regions, the portion classified as the restoration area, not a portion of the compressed depth image that is classified as a bypass area. Accordingly, a filter parameter value for the bypass area may not be determined, and image filtering may not be performed on the bypass area.

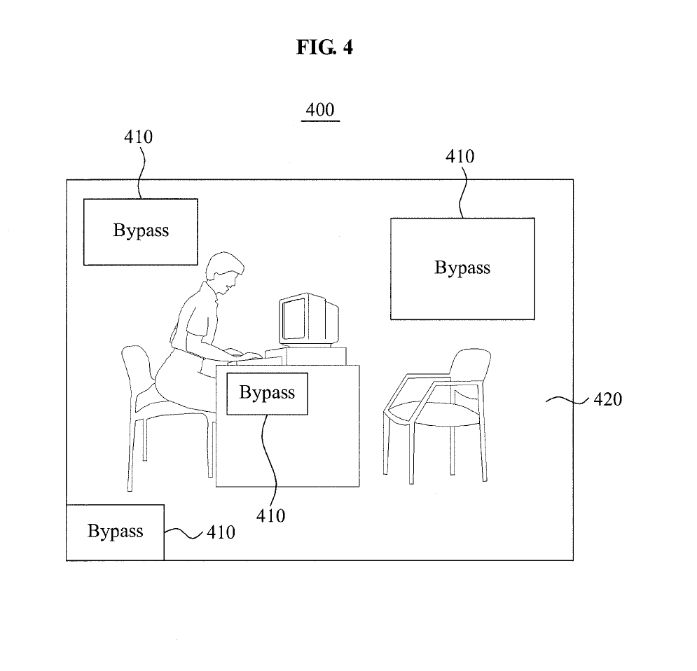

FIG. 4 illustrates a diagram of a bypass area according to example embodiments.

Referring to FIG. 4, an area classifying unit of a depth image processing apparatus according to example embodiments may classify a depth image 400 into a bypass area 410 and a restoration area 420, based on compression information.

The area classifying unit may set, as the bypass area 410, an area of the depth image 400 where a Motion Vector Sharing (MVS) compression scheme is applied.

Here, the depth image processing apparatus may not perform a determination of a filter parameter value, and an image filtering, with respect to the bypass area 410.

Referring back to FIG. 1, the filter parameter value determination unit 120 may determine a filter parameter value corresponding to each of the plurality of classes.

Table 1 shows a plurality of classes based on a flatness, and filter parameters corresponding to the classes.

TABLE 1

| Class | Flatness of regions | Filtering strength |
|---|---|---|
| 1 | Very flat | No filtering |
| 2 | Flat | Filter parameter (2) |
| . . . | | |
| N-1 | Sharp | Filter parameter (N-1) |
| N | Very sharp | Filter parameter (N) |

Referring to Table 1, a class 1 may correspond to a very flat region, for example, a region with a flatness that has a value of “0” to “20.” Accordingly, the depth image processing apparatus 100 may not perform image filtering on a region belonging to the class 1. In other words, the determination unit 120 of the depth image processing apparatus 100 may not determine a filter parameter value.

Additionally, the depth image processing apparatus 100 may classify regions of a depth image into classes 2, N−1, N, and the like, based on a flatness computed for each of the regions. For example, when a value of a flatness is greater than 20 and is equal to or less than 40, the flatness may correspond to the class 2. When a value of a flatness is greater than 80 and is equal to or less than 100, the flatness may correspond to the class N−1. When a value of a flatness is greater than 100, the flatness may correspond to the class N.

The filter parameter value determination unit 120 may determine a filter parameter value corresponding to each of the classes.

According to an aspect, the filter parameter value determination unit 120 may perform image filtering on at least one region included in a single class, using a predetermined filter parameter value, and may compute a cost function. In other words, the filter parameter value determination unit 120 may compute a cost function for the image filtering using the predetermined filter parameter value. Additionally, the filter parameter value determination unit 120 may determine a filter parameter value having a minimum cost function or relatively low cost function as an optimal filter parameter value for a class.

When at least one region is classified into a single class, for example a class 2, among a plurality of classes, the filter parameter value determination unit 120 may extract at least one subsample region from the at least one region, and may determine a filter parameter value corresponding to a restoration filter using the at least one extracted subsample region.

The filter parameter value determination unit 120 may perform image filtering on a subsample region, using a predetermined filter parameter value, and may compute a cost function for the image filtering. Additionally, the filter parameter value determination unit 120 may determine a filter parameter value having a minimum cost function as an optimal filter parameter value for a class.

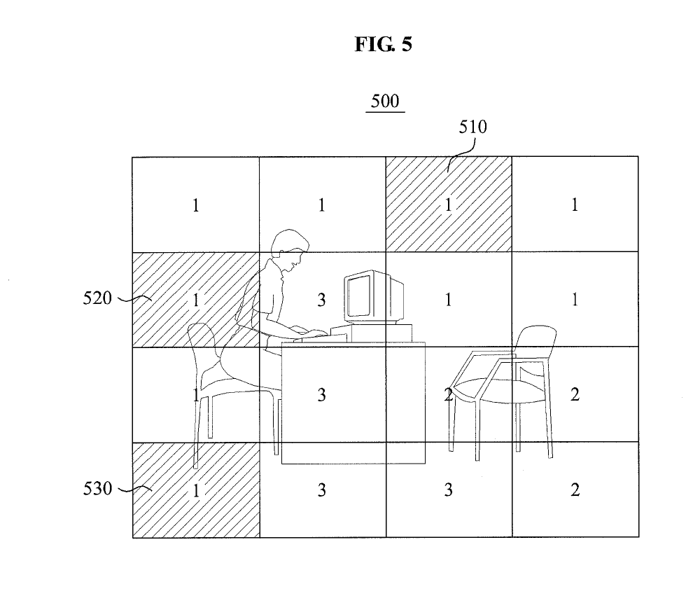

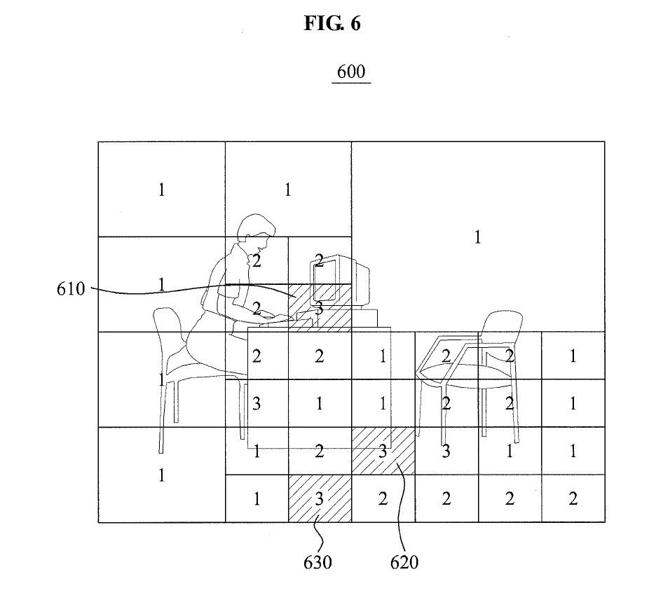

FIGS. 5 and 6 illustrate diagrams of subsample regions according to example embodiments.

Referring to FIG. 5, a filter parameter value determination unit 140 of a depth image processing apparatus according to example embodiments may extract subsample regions 510, 520, and 530 from among a plurality of regions classified as a class 1, in a depth image 500 divided by the block-based division scheme. Here, the filter parameter value determination unit 140 may perform image filtering on the extracted subsample regions 510, 520, and 530, using a predetermined filter parameter value, and may compute a cost function for the image filtering, to determine a filter parameter value corresponding to the class 1. In other words, the determination unit may determine the filter parameter value using only the extracted subsample regions 510, 520, and 530, instead of using all of the plurality of regions belonging to the class 1.

Referring to FIG. 6, a determination unit of a depth image processing apparatus according to example embodiments may extract subsample regions 610, 620, and 630 from among a plurality of regions classified as a class 3, in a depth image 600 divided by the quadtree-based division scheme. Here, the determination unit may perform image filtering on the extracted subsample regions 610, 620, and 630, using a predetermined filter parameter value, and may compute a cost function for the image filtering, to determine a filter parameter value corresponding to the class 3. In other words, the determination unit may determine the filter parameter value using only the extracted subsample regions 610, 620, and 630, instead of using all of the plurality of regions belonging to the class 3.

Referring back to FIG. 1, the image filtering unit 130 may perform image filtering for each of the plurality of classes, based on the computed filter parameter value.

For example, when a first filter parameter value for a class 1 is computed, the image filtering unit 130 may perform image filtering on at least one region belonging to the class 1, using the first filter parameter value. Additionally, when a second filter parameter value for a class 2 is computed, the image filtering unit 130 may perform image filtering on at least one region belonging to the class 2, using the second filter parameter value. Similarly, the image filtering unit 130 may repeatedly perform image filtering on all regions of a compressed depth image, for each of classes 3 to N.

The image filtering unit 130 may perform either a restoration filtering or an interpolation filtering for each of the plurality of classes, based on the filter parameter value.

Additionally, the image filtering unit 130 may perform the image filtering using at least one of a median filter, a weighted median filter, a Wiener filter, a bilateral filter, and a non-local means filter.

The median filter may be used to output a median value of pixel values in a filter window. The bilateral filter may be used to output a product of a Gaussian filter and a range filter. A filter parameter of the bilateral filter may include a parameter used to control a space variance, and a range variance. The non-local means filter may be used to convert images of neighboring areas to image patches, and output a weighted sum of the image patches. A filter parameter of the non-local means filter may include a weight-decay control parameter.

The depth image processing apparatus 100 may further include a transmission unit 150.

The coding and/or transmission unit 150 may entropy code the determined filter parameter value, and may transmit the entropy-coded filter parameter value to a receiving end.

Additionally, the depth image processing apparatus 100 may further include a storage unit 160. The storage unit 100 may be a buffer to store the image.

The storage unit 160 may store a depth image where image filtering is performed. Depending on example embodiments, when the depth image processing apparatus 100 is inserted as a post filter, instead of as a loop filter, into a video data encoder or a video data decoder, the storage unit 160 may not store the depth image where the image filtering is performed.

The depth image processing apparatus 100 may be inserted as a single module into an encoder or decoder of a stereoscopic image compression system, and may perform image filtering on a stereoscopic image. Here, the encoder and the decoder may include, for example, a video data encoder, and a video data decoder, respectively.

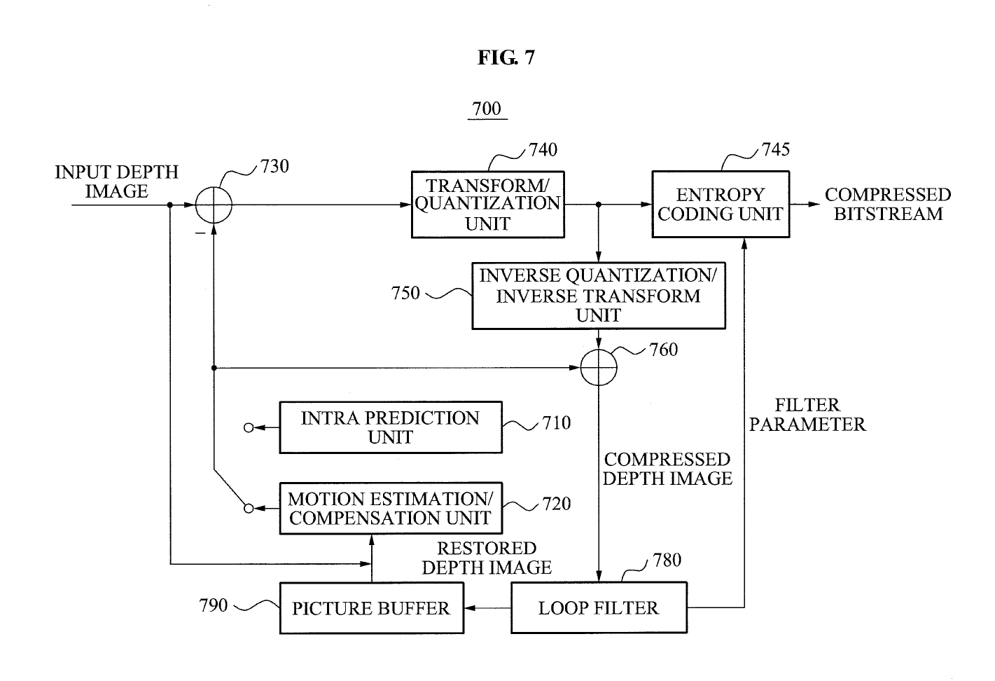

FIG. 7 illustrates a diagram of a video data encoder including a depth image processing apparatus in an in-loop position according to example embodiments.

Referring to FIG. 7, the depth image processing apparatus may be included as a loop filter 780 in a video data encoder 700.

The video data encoder 700 may include an intra prediction unit 710, a motion estimation/compensation unit 720, an addition unit 730, a transform/quantization unit 740, an entropy coding unit 745, an inverse quantization/inverse transform unit 750, an addition unit 760, the loop filter 780, and a picture buffer 790. In other words, the depth image processing apparatus may be inserted as the loop filter 780 in the in-loop configuration of the video data encoder 700.

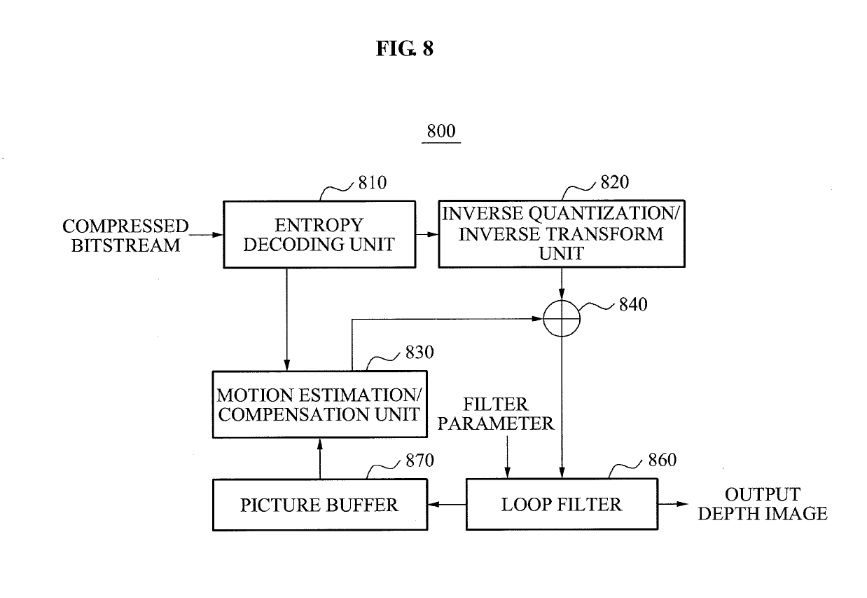

FIG. 8 illustrates a diagram of a video data decoder including a depth image processing apparatus in an in-loop position according to example embodiments.

Referring to FIG. 8, the depth image processing apparatus may be included as a loop filter 860 in a video data decoder 800.

The video data decoder 800 may include an entropy decoding unit 810, an inverse quantization/inverse transform unit 820, a motion estimation/compensation unit 830, an addition unit 840, the loop filter 860, and a picture buffer 870. In other words, the depth image processing apparatus may be inserted as the loop filter 860 in the in-loop configuration of the video data decoder 800.

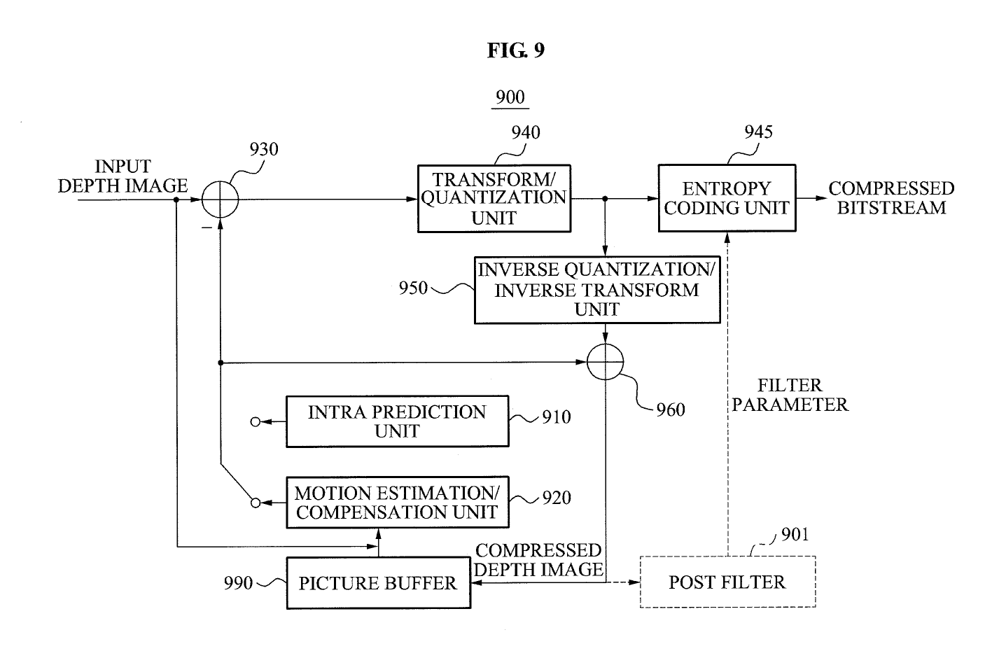

FIG. 9 illustrates a diagram of a video data encoder 900 including a depth image processing apparatus in a position of a post filter according to example embodiments.

Referring to FIG. 9, the depth image processing apparatus may be included as a post filter 901 in the video data encoder.

The video data encoder 900 may include an intra prediction unit 910, a motion estimation/compensation unit 920, an addition unit 930, a transform/quantization unit 940, an entropy coding unit 945, an inverse quantization/inverse transform unit 950, an addition unit 760, post filter 901, and a picture buffer 990. In other words, the depth image processing apparatus may be inserted in a position of the post filter 901 of the video data encoder 900.

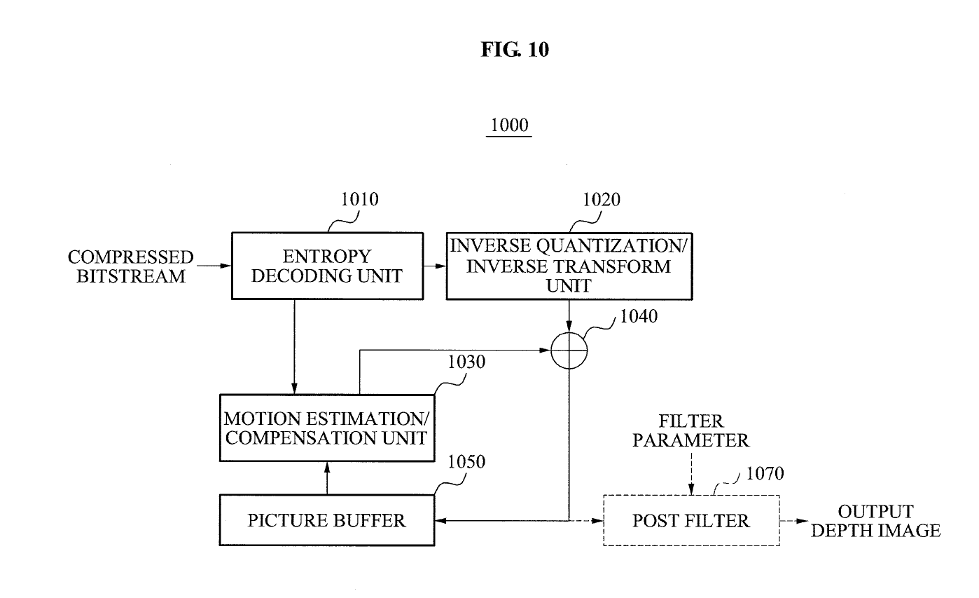

FIG. 10 illustrates a diagram of a video data decoder including a depth image processing apparatus in a position of a post filter according to example embodiments.

The video data decoder 1000 may include an entropy decoding unit 1010, an inverse quantization/inverse transform unit 1020, a motion estimation/compensation unit 1030, an addition unit 1040, a picture buffer (storage unit) 1050, and a post filter 1070. In other words, the depth image processing apparatus may be inserted as the post filter 1070 in the video data decoder 1000.

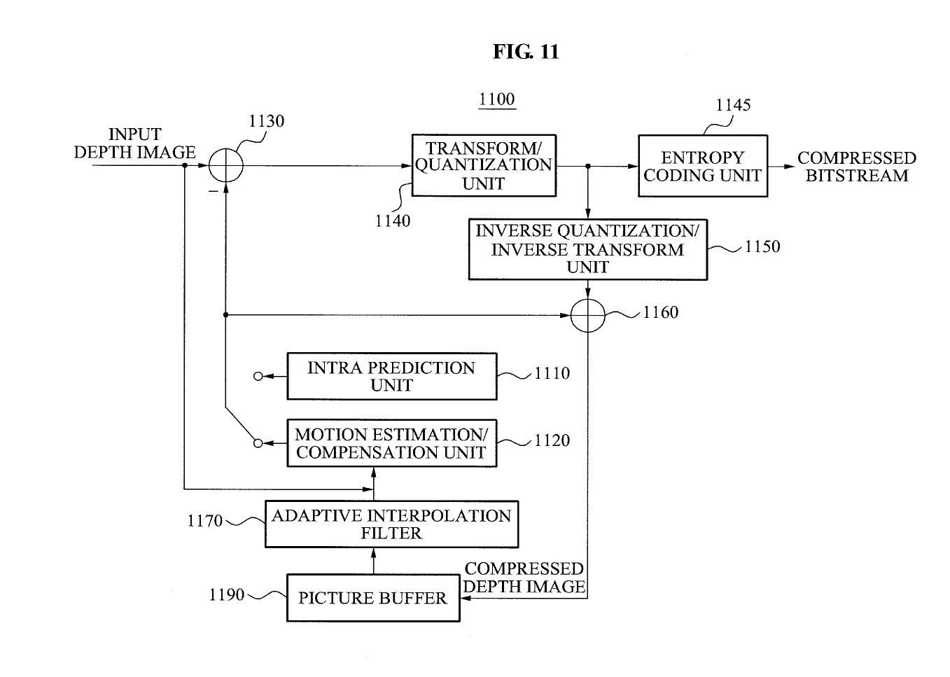

FIG. 11 illustrates a diagram of a video data encoder 1100 including a depth image processing apparatus in a position of an adaptive interpolation filter according to example embodiments.

Referring to FIG. 11, The video data encoder 1100 may include an intra prediction unit 1110, a motion estimation/compensation unit 1120, an addition unit 1130, a transform/quantization unit 1140, an entropy coding unit 1145, an inverse quantization/inverse transform unit 1150, an addition unit 1160, the adaptive interpolation filter 1170, and a storage unit (picture buffer) 1190. In other words, the depth image processing apparatus may be inserted as the adaptive interpolation filter 1170 of the video data encoder 1100.

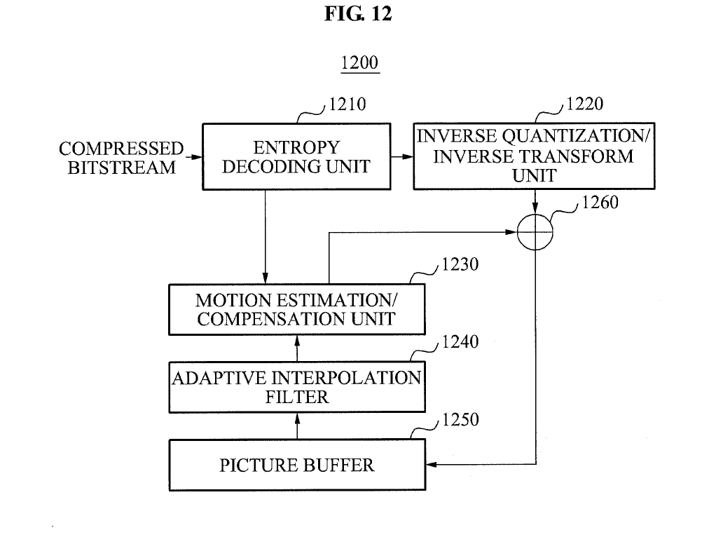

FIG. 12 illustrates a diagram of a video data decoder including a depth image processing apparatus in a position of an adaptive interpolation filter according to example embodiments.

Referring to FIG. 12, The video data decoder 1200 may include an entropy decoding unit 1210, an inverse quantization/inverse transform unit 1220, a motion estimation/compensation unit 1230, an addition unit 1260, a picture buffer (storage unit) 1250, and an adaptive interpolation filter 1240. In other words, the depth image processing apparatus may be inserted as the adaptive interpolation filter 1240 in the video data decoder 1200.

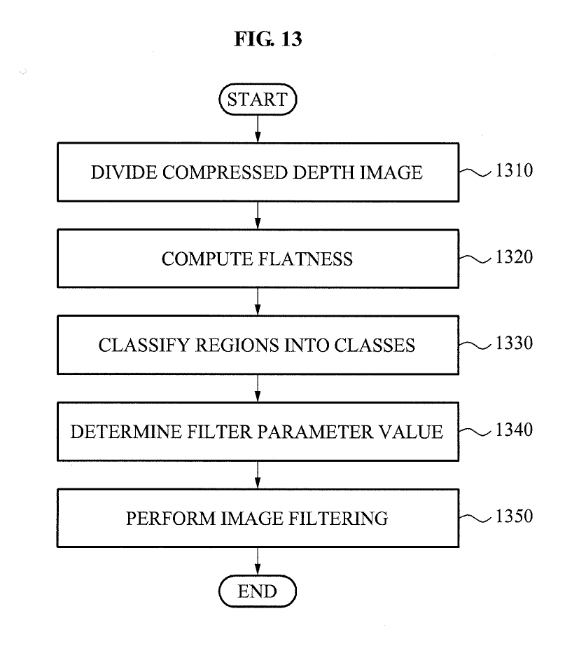

FIG. 13 illustrates a flowchart of a depth image processing method according to example embodiments.

Referring to FIG. 13, in operation 1310, a compressed depth image may be divided into a plurality of regions.

Specifically, the compressed depth image may be divided into the plurality of regions, based on one of a block-based division scheme and a quadtree-based division scheme.

In operation 1320, a flatness may be computed for each of the plurality of regions.

According to an aspect, the flatness may be a difference between a maximum pixel value and a minimum pixel value in each of the plurality of regions.

For example, when a compressed depth image is divided into ‘4×4’ regions, namely, 16 regions, a flatness may be computed for each of the 16 regions. In this example, a maximum pixel value and a minimum pixel value may be extracted from a plurality of pixels included in a first region among the 16 regions, and a difference between the extracted maximum pixel value and the extracted minimum pixel value may be computed, so that a flatness of the first region may be computed. Similarly, a flatness computation operation may be repeatedly performed for each of the other 15 regions, to compute a flatness for each of the other 15 regions.

According to another aspect, the flatness may be a variance of a pixel value in each of the plurality of regions.

According to another aspect, the flatness may be a spatial activity of a pixel in each of the plurality of regions. The spatial activity may represent a gradient of a pixel.

In operation 1330, the plurality of regions may be classified into a plurality of classes, based on the computed flatness.

According to an aspect, the compressed depth image may be classified into a bypass area and a restoration area, based on compression information regarding the compressed depth image.

The compression information may include at least one of a scheme used to compress the depth image, motion information, an intra prediction mode, and a direction of a residue.

Here, a portion of the compressed depth image that is classified as a restoration area may be divided into a plurality of regions. In other words, only the portion classified as the restoration area may be divided into the plurality of regions, and a portion of the compressed depth image that is classified as a bypass area may not be divided. Accordingly, a filter parameter value for the bypass area may not be determined, and image filtering may not be performed on the bypass area.

In operation 1340, a filter parameter value corresponding to each of the plurality of classes may be determined.

According to an aspect, image filtering may be performed on at least one region included in a single class, using a predetermined filter parameter value, and a cost function may be computed. In other words, a cost function for the image filtering using the predetermined filter parameter value may be performed. Additionally, a filter parameter value having a minimum cost function may be determined as an optimal filter parameter value for a class.

When at least one region is classified into a single class, for example a class 2, among a plurality of classes, at least one subsample region may be extracted from the at least one region, and a filter parameter value corresponding to a restoration filter may be determined using the at least one extracted subsample region.

Additionally, image filtering may be performed on a subsample region, using a predetermined filter parameter value, and a cost function for the image filtering may be computed. Furthermore, a filter parameter value having a minimum cost function may be determined as an optimal filter parameter value for a class.

In operation 1350, an image filtering may be performed for each of the plurality of classes, based on the computed filter parameter value.

For example, when a first filter parameter value for a class 1 is computed, image filtering may be performed on at least one region belonging to the class 1, using the first filter parameter value. Additionally, when a second filter parameter value for a class 2 is computed, image filtering may be performed on at least one region belonging to the class 2, using the second filter parameter value. Similarly, image filtering may be repeatedly performed on all regions of a compressed depth image, for each of classes 3 to N.

Either a restoration filtering or an interpolation filtering may be performed for each of the plurality of classes, based on the filter parameter value.

The image filtering may be performed using at least one of a median filter, a weighted median filter, a Wiener filter, a bilateral filter, and a non-local means filter.

The median filter may be used to output a median value of pixel values in a filter window. The bilateral filter may be used to output a product of a Gaussian filter and a range filter. A filter parameter of the bilateral filter may include a parameter used to control a space variance, and a range variance. The non-local means filter may be used to convert images of neighboring areas to image patches, and output a weighted sum of the image patches. A filter parameter of the non-local means filter may include a weight-decay control parameter.

The determined filter parameter value may be entropy coded, and the entropy-coded filter parameter value may be transmitted to a receiving end.

A depth image where image filtering is performed may be stored in a picture buffer (storage unit). Depending on example embodiments, when a depth image processing apparatus used to perform the depth image processing method is inserted as a post filter, instead of as a loop filter, into a video data encoder or a video data decoder, the depth image where the image filtering is performed may not be stored in the picture buffer (storage unit).

The above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. An apparatus for processing a depth image, the apparatus comprising:
a region division unit to divide a compressed depth image into a plurality of regions, to compute a flatness for each of the plurality of regions, and to classify the plurality of regions into a plurality of classes based on the flatness;
a filter parameter value determination unit to determine a filter parameter value corresponding to the plurality of classes; and
an image filtering unit to perform an image filtering for the plurality of classes based on the filter parameter value.

2. The apparatus of claim 1, wherein the region division unit divides the compressed depth image into the plurality of regions, based on one of a block-based division scheme and a quadtree-based division scheme.

3. The apparatus of claim 1, wherein the region division unit divides the compressed depth image into the plurality of regions based on an object-based division scheme.

4. The apparatus of claim 1, wherein the flatness is a difference between a maximum pixel value and a minimum pixel value in the plurality of regions.

5. The apparatus of claim 1, wherein the flatness is a variance of a pixel value in each of the plurality of regions.

6. The apparatus of claim 1, wherein the flatness is a spatial activity of a pixel in each of the plurality of regions.

7. The apparatus of claim 1, wherein, when at least one region is classified into a class among the plurality of classes, the filter parameter value determination unit extracts at least one subsample region from the at least one region, and determines the filter parameter value using the at least one extracted subsample region.

8. The apparatus of claim 1, wherein the image filtering unit performs the image filtering using at least one of a median filter, a weighted median filter, a Wiener filter, a bilateral filter, and a non-local means filter.

9. The apparatus of claim 1, wherein the image filtering unit performs either a restoration filtering or an interpolation filtering for each of the plurality of classes, based on the filter parameter value.

10. The apparatus of claim 1, further comprising:
a coding and/or transmission unit to entropy code the filter parameter value, and/or to transmit the entropy-coded filter parameter value to a receiving end.

11. The apparatus of claim 1, further comprising:
a storage unit to store the depth image where the image filtering is performed.

12. The apparatus of claim 1, further comprising:
an area classifying unit to classify the compressed depth image into a bypass area and a restoration area, based on compression information regarding the compressed depth image,
wherein the region division unit divides, into the plurality of regions, a portion of the compressed depth image that is classified as the restoration area.

13. A method for processing a depth image, the method comprising:
dividing a compressed depth image into a plurality of regions;
computing a flatness for each of the plurality of regions;
classifying the plurality of regions into a plurality of classes based on the flatness;
determining a filter parameter value corresponding to a restoration filter, for each of the plurality of classes; and
performing an image filtering for the plurality of classes, based on the filter parameter value.

14. The method of claim 13, wherein the determining comprises, when at least one region is classified into a class among the plurality of classes, extracting at least one subsample region from the at least one region, and determining the filter parameter value using the at least one extracted subsample region.

15. The method of claim 13, further comprising:
classifying the compressed depth image into a bypass area and a restoration area, based on compression information regarding the compressed depth image,
wherein the dividing comprises dividing, into the plurality of regions, a portion of the compressed depth image that is classified as the restoration area.

16. A non-transitory computer readable recording medium storing a program to cause a computer to implement the method of claim 13.

17. A method for processing a depth image, the method comprising:
dividing the depth image a plurality of regions;
determining a filter parameter value corresponding to a restoration filter based on a flatness of the plurality of region; and
performing an image filtering for based on the filter parameter value.

18. The method of claim 17, further comprising:
classifying the plurality of regions by a bypass regions and restoration regions;
wherein the determining the filter parameter value only for the restoration regions.

19. An apparatus for coding video data, the apparatus comprising:
an addition unit to produce a difference signal a depth image data and motion compensated depth image data;
a transform/quantization unit to perform a transform and quantization the difference signal received from the addition unit;
an entropy coding unit to perform entropy coding an received signal from the transform/quantization unit based on a filter parameter;
an inverse quantization/inverse transform unit to perform an inverse quantization and an inverse transformation the data received from the transform/quantization unit;
an addition unit to add an motion compensated video data and an outputted video data from the inverse quantization/inverse transform unit;
a filter to perform image filtering an depth image data inputted by the addition unit based;
an storage unit to store a filtered depth image data; and
a motion estimation/compensation unit to estimate a motion vector of the received video data and to perform motion compensation based on the estimated motion vector by using the inputted depth image data and received from the storage unit.

20. An apparatus for decoding video data, the apparatus comprising:
a addition unit to produce a difference signal a present video data and motion compensated video data;
an entropy decoding unit to entropy decoding a received video data;
an inverse quantization/inverse transform unit to perform an inverse quantization and an inverse transformation the decoded data received from the entropy decoding unit;
an addition unit to add a motion compensated video data and an outputted video data from the quantization/inverse transform unit;
a filter to perform image filtering a video data inputted by the addition unit based on a filter parameter value;
a storage unit to store a filtered video data; and
a motion estimation/compensation unit to estimate a motion vector of the received video data and to perform motion compensation based on the estimated motion vector by using video data received from the entropy decoding unit and the storage unit.
